(19) United States
(12) Patent Application Publication
(10) Pub. No.: US 2024/0336326 A1
(43) Pub. Date: Oct. 10, 2024

(54) PLUG INTERFACE, PLUG ELEMENT, MICROMOBILITY VEHICLE

(71) Applicant: ZF Friedrichshafen AG, Friedrichshafen (DE)

(72) Inventors: Jakob Lauhoff, Tübingen (DE); Martin Schneider, Bad Urach (DE); Lukas Hubert, Bad-Soden - Salmünster (DE)

(73) Assignee: ZF Friedrichshafen AG, Friedrichshafen (DE)

(21) Appl. No.: 18/579,098

(22) PCT Filed: Jul. 7, 2022
(86) PCT No.: PCT/EP2022/068927

§ 371 Date: Jan. 12, 2024

(30) Foreign Application Priority Data
Jul. 14, 2021 (DE) 10 2021 207 466.9

(51) Int. Cl. B62M 6/80; H01R 13/62

(52) U.S. Cl. CPC B62M 6/80; H01R 13/6205; H01R 2201/26

(57) ABSTRACT

A plug interface for a micromobility vehicle can be detachably connected to a first connection area of a plug element and integrated in a frame of the micromobility vehicle. The plug interface comprises a connecting element with at least one magnetic means designed to produce a magnetic force of attraction with corresponding magnetic means of the first connection area of the plug element. The plug interface can be connected energy-efficiently to an energy storage device of the micromobility vehicle. The connecting element of the plug interface has at least one contact surface designed to be contacted by at least one spring-loaded pin of the plug element in such manner that an energy-efficient contact is made. The input voltage of the plug interface can be up to 12 V. The output voltage that can be supplied to the plug element by the plug interface (101) is up to 12 V.

### RELATED APPLICATIONS

This application claims the benefit under 35 U.S.C. § 371 as a U.S. National Phase Application of application no. PCT/EP2022/068927, filed on 7 Jul. 2022, which claims the benefit of German Patent Application no. 10 2021 207 466.9 filed on 14 Jul. 2021, the contents of which are hereby incorporated herein by reference in their entireties.

### FIELD OF THE DISCLOSURE

The invention relates to a plug interface, a plug element, and a micromobility vehicle.

### BACKGROUND

From the prior art, micromobility vehicles are known, such as Pedelecs, e-bikes, e-scooters, or Velomobiles, all of which have plug interfaces. These are contacted by a corresponding counterpart. To fix the counterpart, the plug interfaces have mechanical fixing elements, such as a USB interface. This is a disadvantage, having regard to the fitting space available. Furthermore, it is difficult to protect the plug interfaces against dust and humidity. In the event of a fall, the mechanical fixing elements are at risk of being damaged.

From JP20171-3942A an e-bike with an energy storage device is known. It is shown that a mobile terminal device can be connected to the energy storage device by means of a USB interface.

### SUMMARY

The purpose of the present invention is to avoid the disadvantages mentioned above. This objective is achieved by a plug interface, a plug element and a micromobility vehicle as disclosed herein. Preferred further developments will emerge from the description given below.

A plug interface for a micromobility vehicle is designed to be detachably connected to a first connection area of a plug element and to be integrated in a frame of the micromobility vehicle. The plug interface comprises a connecting element with at least one magnetic means designed to produce a force of attraction with a corresponding magnetic means of a first connection area of the plug element. The plug interface is designed to be connected in an energy-efficient manner to an energy storage device of the micromobility vehicle. The connecting element of the plug interface comprises at least one contact surface, such that the at least one contact surface is designed to be contacted by at least one spring-loaded pin of the plug element so that an energy-efficient connection is established. The input voltage of the plug interface is up to 12 V. The output voltage that can be supplied to the plug element by way of the plug interface is up to 12 V.

A micromobility vehicle is defined as a vehicle which comprises an (auxiliary) electric motor, but which can also be operated by muscle power. The micromobility vehicle can be driven by the electric motor alone, i.e., without simultaneously being driven by muscle power (such as pedaling or powering by hand or by foot), by the electric motor in combination with muscle power, or by muscle power alone. When driving by means of the electric motor in combination with muscle power, the electric motor assists the driver. The micromobility vehicle is suitable for individual transport. For example, the micromobility vehicle can be designed as an e-bike, an (S-) Pedelec, a Velomobile, an e-scooter, a monowheel or as other suitable vehicles.

The plug interface is designed to be detachably connected to a first connection area of the plug element. This connection can be released and closed repeatedly. The connection between the plug interface and the plug element is made by means of a magnetic force of attraction; no mechanical connection is closed. In particular, there is no engagement of a pin in a socket for the pin. For that purpose, the plug interface comprises the connecting element, which in turn comprises at least one magnetic means. In this case the magnetic means can either be made as one piece or from a number of part-elements. Preferably, the magnetic means is designed such that it comprises at least one recess in which a contact surface can be accommodated. The magnetic means can be a magnet or a ferromagnetic material. At least one of the two magnetic means of the plug interface and the plug element is a magnet, whereas the other means ca be another magnet or a ferromagnetic material.

By virtue of the magnetic force of attraction between the respective magnetic means, the plug element is fixed in the contacting condition against the plug interface. To release the plug element from the plug interface, it is only necessary to overcome the magnetic force of attraction. By virtue of the magnetic means mechanical means for fixing the plug element are rendered obsolete. In that way the disadvantages mentioned at the start in connection with mechanical fixing means are avoided.

The plug interface is designed to be integrated in a frame of the micromobility vehicle. In other words, the frame has a holding feature into which the plug interface is inserted. Thus, as a further development at least part of the plug interface is joined to the frame. The housing of the plug interface is then fixed to the frame, preferably bolted onto the frame. Preferably the fixing of the plug interface to the frame is solid, i.e., without any possibility of relative movement between the plug interface and the frame. If the plug interface is integrated in the frame, a plane is formed such that the plug interface projects out of the frame only to a very small extent. Preferably, the plug interface does not project out of the frame at all.

The plug interface is designed to be connected to an energy storage device of the micromobility vehicle in an energy-efficient manner. In this context energy-efficient means that the plug interface can be supplied with energy by way of the energy storage device. The input voltage supplied to the plug interface from the energy storage device is up to 12 V. In other words, energy is delivered by the energy storage device to the plug interface. In this and any further numerical data in this description it should be borne in mind that mentioned values are always to be understood as having a tolerance customary for the technical field of application concerned.

The connecting element of the plug interface comprises the at least one contact surface, this at least one contact surface being designed to be contacted by at least one spring-loaded pin of the plug element, so establishing an energy-efficient connection. The at least one contact surface is shaped as a flat surface. This is preferably fixed solidly, i.e., it is built into the plug interface with no possibility of relative movement. The at least one contact surface is made from an electrically conductive material. By way of the at least one contact surface current and/or electrical voltage can be delivered to the plug element when the at least one contact surface is contacted by the at least one spring-loaded pin of the plug element. This connection, for the purpose of energy transfer, is referred to as an energy-efficient connection. In this contacting condition the pins do not engage in the contact surface but only touch it.

The output voltage, with which the plug interface supplies the plug element when the plug element is connected to the plug interface, can be up to 12 V. The plug interface can comprise a transformer which can transform the voltage, so that the output voltage of the plug interface is lower than the input voltage of the plug interface. For example, the output voltage of the plug interface can be 5 V or 9 V.

An advantage of the plug interface and of a system consisting of the plug interface and the plug element, is that even if this gets dirty it is simple to restore the plug interface to functionality. The dirt can simply be wiped away. No dirt that could prevent contacting by means of the plug element can get into the plug interface.

In a further developed embodiment, the contacting element of the plug interface has at least three and in particular four contact surfaces, each contact surface being designed to be contacted by a corresponding spring-loaded pin so that an energy-efficient connection is made. At least two of these at least three contact surfaces serve exclusively for energy transfer. In that case one contact surface can be designed as a grounding contact. The contact surfaces can for example be arranged in series with one another. Obviously, any other arrangement is also possible. All the contact surfaces lie in a common plane. Obviously, the connecting element of the plug interface can have more than four contact surfaces.

The plug element, which forms the counterpart of the plug interface, has the same number of pins as the plug interface has contact surfaces. In other words, for each contact surface there is one pin. Thus, the plug interface and the plug element are made to fit one another. Contacting the plug interface with a plug element that does not have the same number of pins as there are contact surfaces, is not possible.

The magnetic force acting between the magnetic means of the plug interface and the plug element is calculated to be such that it overcomes the sum of all the spring forces acting between each contact surface and the corresponding contact pin.

The contact surfaces are designed such that on contact with water they are not short-circuited. Moreover, bridging by means of an unsuitable structural element, such as by means of a paper clip or by means of a piece of wire, is not possible. Thus, the contact surfaces are designed such that they cannot be short-circuited. This ensures greater safety for a user of the vehicle.

According to a further developed embodiment at least one of the contact surfaces is also designed to be a data transmission device. Thus, in particular, data can be coded in the electrical signals transmitted. For example, the data can be diagnostic data. The plug interface is then further developed at least partially as a diagnosis interface. By way of the diagnosis interface a diagnosis unit can be connected to the micromobility vehicle as an external unit by means of the plug element. The diagnosis unit enables access to diagnostic data regarding electric or electronic components of the micromobility vehicle.

In a further developed embodiment, a maximum charging power of up to 20 W is available for the plug element via the connecting element of the plug interface. This charging power can then be supplied via the plug element, for example to a mobile terminal device such as a smartphone, tablet, diagnosis unit, smartwatch or other device. In other words, the mobile terminal device, or more precisely the energy storage device of the mobile terminal device, can be charged from the energy storage device of the micromobility vehicle by way of the plug element.

The plug element for use with a plug interface, which has already been described, and for use with a mobile device, comprises a magnetic means. The plug element is designed, with its magnetic means arranged on its first connection area, to be detachably connected to the at least one magnetic means of the plug interface. In that way a magnetic force of attraction is produced. The plug element has a second connection area which is designed to be detachably connected to an interface of a mobile terminal device. On its first connection area the plug element also comprises at least one spring-loaded pin, which is designed to make contact with the corresponding contact surface of the plug interface. Between the at least one pin and the corresponding contact surface of the plug interface an energy-efficient connection is formed.

The magnetic means of the plug element can either be made as one piece, or from several part-elements. Preferably the magnetic means are formed with at least one recess into which a pin can fit. The magnetic means can be a magnet or a ferromagnetic material. At least one of the two magnetic means of the plug interface and the plug element is a magnet, whereas the other means can be another magnet or a ferromagnetic material.

The pin is a contact pin comprising a spring which prestresses the pin. Thus, the pin is acted upon by a spring force which counteracts any displacement of the pin. To make contact, the pin is pressed against the contact surface of the plug interface. Such pins can be called pogo-pins, for example. The at least one pin is electrically conductive. When the at least one pin contacts its corresponding contact surface of the plug interface, energy can be transmitted to the plug element. Thus, when the plug interface and the plug element are used in a micromobility vehicle, energy from the energy storage device of the micromobility vehicle can be delivered via the plug interface to the plug element.

The first connection area can have more than one pin. In particular, the first connection area can have two, three, four, or even more pins. The number of pins is determined by the number of corresponding contact surfaces of the plug interface. The first connection area, that of the plug interface, is connected to the second connection area, that of the plug element, by means of a cable.

It is an advantage of the plug element that, by virtue of the pins, non-intrusive contacting of the corresponding contact surfaces is made possible. If the micromobility vehicle is involved in an accident, the plug element is detached non-destructively from the plug interface. This prevents damage to the plug interface and/or the plug element.

According to another further developed embodiment, the second connection area is in the form of a USB interface or a Lightning interface. A mobile terminal device can be connected to the second connection area, for example a smartwatch, a tablet, a diagnosis unit, a smartphone, or some other device. The USB interface can be, for example, in the form of a USB-A, USB-B, USB-C, or a mini-USB, a micro-USB, or some other USB device. By way of the second connection area, besides energy transmission data transmission can also take place.

If the mobile terminal device is in the form of a diagnosis unit, access to diagnostic data regarding electric or electronic components of the micromobility vehicle is made possible if the plug element is used with a micromobility vehicle and one of the contact surfaces of the plug interface is additionally in the form of a data transmission device.

By way of the second contacting area of the plug element an output voltage of up to 12 V can be supplied to the mobile terminal device. For example, an output voltage of 5 V or 9 V can be provided. For example, a charging power of up to 20 W can be supplied in order to charge the energy storage device of the mobile terminal device.

A micromobility vehicle comprises an energy storage device. The micromobility vehicle comprises a plug interface, which has been described already. The plug interface is integrated in the frame of the micromobility vehicle, and the plug interface is connected to the energy storage device of the mobile terminal device in an energy-efficient manner. This has also been described already.

### BRIEF DESCRIPTION OF THE DRAWINGS

Example embodiments of the invention are shown in FIGS. 1, 2 and 3, which show:

FIG. 1: A schematic representation of a micromobility vehicle with a plug interface and a plug element, according to an example embodiment.

FIG. 2: The plug interface and the plug element shown in FIG. 1.

FIG. 3: The plug interface from FIGS. 1 and 2.

### DETAILED DESCRIPTION

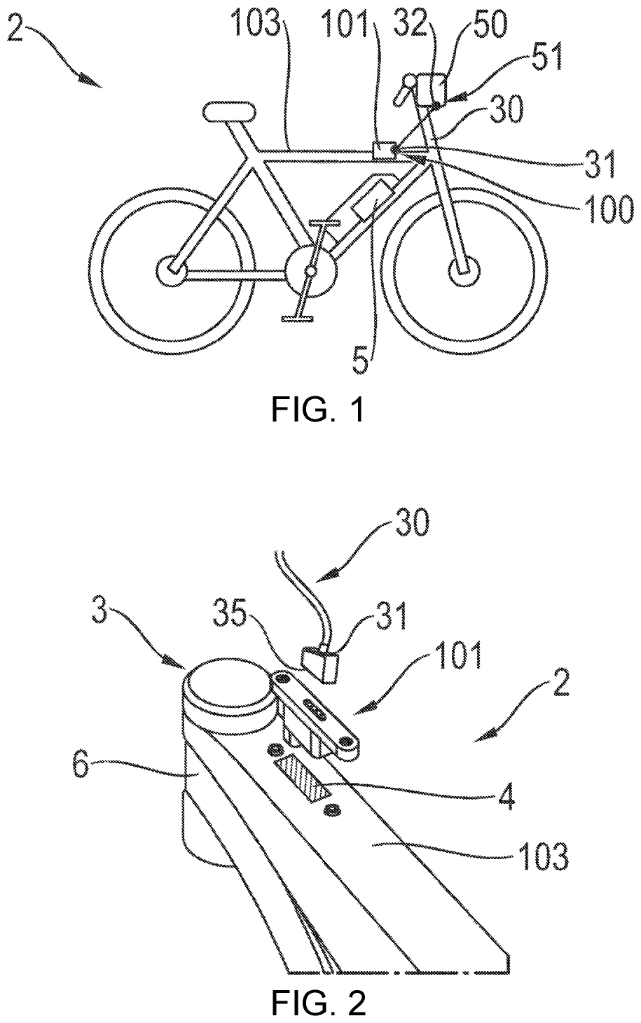

FIG. 1 shows a micromobility vehicle 2 with a plug interface 101 and a plug element 30, according to an example embodiment. The micromobility vehicle 2 comprises a frame 103, an energy storage device 5, and a plug interface 101. In this case, for example, the micromobility vehicle 2 is in the form of a Pedelec. Furthermore, a mobile terminal device 50 and a plug element 30 are shown.

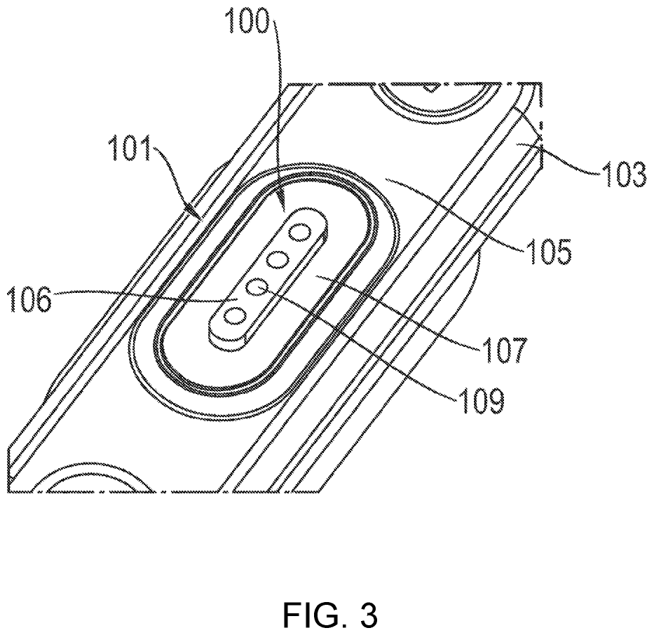

The energy storage device 5 is connected to the plug interface 101 in an energy-efficient manner. Here, this is illustrated only schematically. The plug interface 101 comprises a connecting element 100, which is connected to the first connection area 31 of the plug element 30. The connecting element 100 is shown in greater detail in FIGS. 2 and 3.

The second connection area 32 of the plug element 30 is connected via its interface 51 to the mobile terminal device 50. The first connection area 31 and the second connection area 32 are connected to one another by a cable. In the arrangement shown here the mobile terminal device 50 can be charged with energy from the energy storage device 5 of the micromobility vehicle 2. The energy is delivered from the energy storage device 5 to the plug interface 101 by way of the plug element 30 and on to the mobile terminal device 50.

FIG. 2 shows the plug interface 101 and the plug element 30 from FIG. 1. The plug interface 101 is shown before it has been fitted into the frame 103. The plug element 30 is not connected to the plug interface 101.

The frame 103 has a holding feature 4 in which the plug interface 101 is held. The housing of the plug interface 101 is then bolted to the frame 103. After it has been fitted, the plug interface 101 projects only very slightly out of the frame 103. It can be seen clearly that the plug interface 101 is located close to the handle-bar connection point 3 of the micromobility vehicle 2.

The plug interface 101 has a connection area 6 by way of which it can be connected to the energy storage device 5 in an energy-efficient manner. Other details of the plug interface 101 are shown in FIG. 3.

The plug element 30 comprises a first connection area 31 on which the four pins corresponding to the four contact surfaces of the plug interface 101 are arranged. On its connection area 6 the plug element 30 also has a magnetic mean 35 which interacts with the magnetic means of the plug interface 101 to produce a magnetic force of attraction.

FIG. 3 shows the plug interface 101 from FIGS. 1 and 2 in detail. The plug interface 101 is let into the frame 103 of the micromobility vehicle. The plug interface 101 comprises the connecting element 100. The plug interface 101 comprises the housing 105 with which it is fixed into the frame 103. In turn, in the housing 105 there are arranged a magnetic means 107 in the form of a magnet and four contact surfaces 109. The magnetic means 107 has recesses in which the contact surfaces 109 are arranged. The housing 105 has a housing cover surface 106 which forms a common plane with the contact surfaces 109.

If the corresponding plug element is placed onto the plug interface 101, the magnetic means 107 of the plug element with its corresponding magnetic means holds it onto the plug interface 101. Spring-loaded pins of the corresponding plug element are in each case pressed against a corresponding contact surface 109. This results in electrically conducting connections between the pins and the contact surfaces 109.

In order to center the corresponding plug element on the plug interface 101, the magnetic means 107 is arranged slightly recessed relative to a rim formed by the housing 105. The corresponding plug element forms a corresponding raised area which engages in the recess of the plug interface 101.

### INDEXES

2 Micromobility vehicle
3 Handle-bar connection point
4 Holding feature
5 Energy storage device
6 Connection area
30 Plug element
31 First connection area
32 Second connection area
35 Magnetic means of the pug element
50 Mobile terminal device
51 Interface of the mobile terminal device
100 Connecting element
101 Plug interface
103 Frame
105 Housing
106 Housing cover surface
107 Magnetic means of the plug interface
109 Contact area

1. A plug interface (101) for a micromobility vehicle (2) having a frame,
comprising:
a plug element having a first connection area (31) with a magnetic means (35), and at least one spring-loaded pin; and
a connecting element (100) having at least one magnetic means (107) configured to produce a magnetic force of attraction with corresponding magnetic means (35) of the first connection area (31) of the plug element (30), and at least one contact surface (109) configured to be contacted by the at least one spring-loaded pin of the plug element (30), whereby an energy-efficient connection can be formed, and the plug interface (101) is configured to be connected energy-efficiently to an energy storage device (5) of the micromobility vehicle (2);
wherein the plug interface (1010) is configured to be detachably connected to the first connection area (31) of a plug element (30);
wherein the plug interface is configured to be integrated in a frame (103) of the micromobility vehicle (2); and
wherein the input voltage of the plug interface (101) is up to 12 V and wherein the output voltage is up to 12 V, which can be supplied to the plug element (30) by way of the plug interface (101).

2. The plug interface (101) according to claim 1, wherein the connecting element (100) of the plug interface (101) comprises at least three contact surfaces (109), such that each contact surface (109) is configured to be contacted by a corresponding spring-loaded pin of the plug element (30) in order to form an energy-efficient connection.

3. The plug interface (101) according to claim 2, wherein at least one of the contact surfaces (109) is also made as a data transmission device.

4. The plug interface (101) according to claim 1, wherein the plug element (30) has a maximum charging power of up to 20 W by way of the connecting element (100).

5. In combination, the plug element (30) for use with a plug interface (101) according to any of claims 1 to 4 claim 1, and a mobile terminal device (50), wherein
the plug element (30) is configured, with the magnetic means (35) is arranged on a first connection area (31), to be detachably connected to the at least one magnetic means (107) of the plug interface (101);
wherein:
the plug element (30) comprises a second connection area (32) configured to be detachably connected to an interface (51) of a mobile terminal device (50);
the first connection area (31) of the plug element (30) comprises the at least one spring-loaded pin the at least one spring-loaded pin configured to be contacted by the corresponding contact surface (109) of the plug interface so that a magnetic force of attraction is produced between the magnetic means (35) of the plug element (30) and the magnetic means (107) of the plug interface (101), and wherein an energy-efficient connection is formed between the at least one pin and the corresponding contact surface (109) of the plug interface (101).

6. The combination according to claim 5, wherein the second connection area is made as a USB interface or as a Lightning interface.

7. The combination according to claim 5, wherein an output voltage of up to 12 V can be supplied by way of the second connection area (32).

8. A micromobility vehicle (2) comprising an energy storage device (5), wherein the micromobility vehicle (2) comprises a plug interface (101) according to claim 1, such that the plug interface (101) is integrated in the frame (103) of the micromobility vehicle (2), and the plug interface (101) is connected to the energy storage device (5) of the micromobility vehicle (2) in an energy-efficient manner.
